(19) United States
(12) Patent Application Publication
(10) Pub. No.: US 2007/0271230 A1
(43) Pub. Date: Nov. 22, 2007

(54) Method and apparatus for accessing history trails for previous search sessions

(76) Inventors: Matt E. Hart, Lunenburg, MA (US); Tara L. Tarapata, North Andover, MA (US); Aseem Kishore, Cambridge, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/437,458

(22) Filed: May 19, 2006

(51) Int. Cl. G06F 17/30

(52) U.S. Cl. 707/3

(57) ABSTRACT

One embodiment of the present invention provides a system that stores a history trail for a search session to enable the history trail to be subsequently retrieved. During operation, the system assembles a history trail of pages which are visited during the search session. Next, the system stores the history trail in a repository which contains multiple history trails associated with multiple search sessions. This enables a user to subsequently retrieve the history trail from the repository to obtain information related to pages which were visited during the search session.

### BACKGROUND

### Related Art

The present invention relates to computer-based systems that facilitate searching for information.

The rapid growth of the Internet in recent years can largely be attributed to significant developments in the design of search engines, which presently enable anyone with a network connection to quickly obtain information related to almost any topic. For example, it presently takes only a few minutes for a search engine user to research features of a new car, or to obtain scientific articles related to a new drug-delivery mechanism.

By using a search engine to identify web-pages-of-interest, and then following associated links to related web pages, a user can easily navigate through a large number of web pages from different web sites during a single search session. Moreover, during a typical search session, when a user eventually finds an answer to a question, many pages along the way may provide the user with portions of the answer or hints about the answer. Unfortunately, there is presently no way to trace the path which a user traverses to obtain an answer.

Existing browsers allow a user to a save link to a single page, so the page can be easily accessed again. However, existing browsers provide no mechanism to save multiple pages. Furthermore, although existing browsers typically provide “back” and “forward” controls, which allow a user to review and replay accesses for a current search session, a history of these accesses cannot be saved or categorized for later retrieval.

### SUMMARY

One embodiment of the present invention provides a system that stores a history trail for a search session to enable the history trail to be subsequently retrieved. During operation, the system assembles a history trail of pages which are visited during the search session. Next, the system stores the history trail in a repository which contains multiple history trails associated with multiple search sessions. This enables a user to subsequently retrieve the history trail from the repository to obtain information related to pages which were visited during the search session.

In a variation on this embodiment, while storing the history trail, the system tags the history trail with one or more tags. This enables the history trail to be subsequently retrieved based on contents of the one or more tags stored along with the history trail.

In a variation on this embodiment, in response to a request from a user, the system retrieves a previous history trail for a previous search session from the repository.

In a further variation, tagging the history trail involves tagging the history trail with: a user-supplied tag; keywords used to obtain one or more pages for the search session; or keywords within one or more pages visited during the search session.

In a further variation, retrieving the previous history trail involves retrieving the previous history trail based on time/date information for the previous history trail.

In a variation on this embodiment, retrieving the previous history trail involves retrieving the previous history trail based on location information for pages in the previous history trail.

In a variation on this embodiment, retrieving the previous history trail involves retrieving the previous history trail based on user actions associated with pages in the previous history trail.

In a variation on this embodiment, the system additionally displays the previous history trail to the user as a tree structure, wherein nodes represent pages, and wherein links between nodes represent navigation operations between pages associated with the nodes.

In a further variation, the previous history trail is displayed to the user through a user interface, wherein the user interface allows the user to select a node to retrieve an associated page.

In a variation on this embodiment, the system makes the repository accessible to a group of users so that the group of users can share search sessions in the repository.

In a variation on this embodiment, the storing operation takes place as part of a user-initiated save operation.

In a variation on this embodiment, the system caches pages visited during the search session in local storage, so that a subsequent search can return the pages without having to access the pages remotely.

In a variation on this embodiment, a given page in the history trail can include: a web page, a help page, a form associated with an application, a screen, or a document.

In a variation on this embodiment, the history trail stores one or more actions performed by a user. This facilitates undoing and redoing various actions associated with the history trail.

In a variation on this embodiment, the search session can involve: a keyword-based search operation that returns one or more pages; or a navigation operation which follows a link from a current page to a next page.

### BRIEF DESCRIPTION OF THE FIGURES

FIG. 1 illustrates a system that supports storing and retrieving a history trail for a search session in accordance with an embodiment of the present invention.

FIG. 2 illustrates exemplary data structures that support storing and retrieving a history trail in accordance with an embodiment of the present invention.

FIG. 3 illustrates an exemplary list data structure in accordance with an embodiment of the present invention.

FIG. 4 illustrates the process of tagging and storing a history trail in accordance with an embodiment of the present invention.

FIG. 5 illustrates the process of retrieving a history trail in accordance with an embodiment of the present invention.

FIG. 6 illustrates an exemplary display of a history trail as a tree structure in accordance with an embodiment of the present invention.

FIG. 7 illustrates an exemplary tree structure in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Overview

One embodiment of the present invention provides a system that facilitates tagging and saving a “history trail” of pages that have been visited during a search session. This tagged history trail can be recalled to replay/revisit pages (screens) which were previously accessed. This is useful when more than one page which was visited during the search session was relevant to the search. For example, locating the history of a famous person might take you to web sites for a library, a university and an encyclopedia. Note that saving the entire “history trail,” or at least saving a selected portion of the history trail, is easier than saving individual pages in the history trail or a list of web sites containing the individual pages.

In one embodiment of the present invention, the user clicks on a “save” button to permanently store this history trail. The user can optionally save a tag comprising a word or a short phrase that describes the history trail. For example, if a user accesses a help system and finds relevant answers to a question about “setting up automatic transactions” in three different help articles, the user can save the sequence of articles with the tag “automatic transactions” to facilitate easily locating the articles again. Optionally, if the root of the tree is associated with a search engine query, the system can automatically create tags based on the keywords in the query.

In one embodiment of the present invention, saved trees can be viewed by date/time, by location or by tags. Furthermore, a searching mechanism can be used when a large number of history trails and/or tags exist.

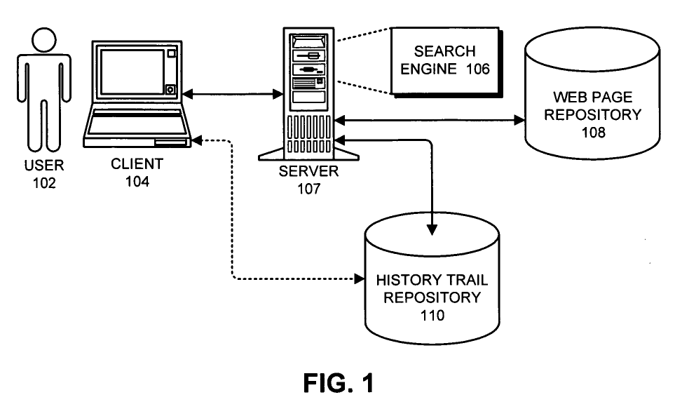

This entire system is described in more detail below with reference to FIGS. 1-5.

### System

FIG. 1 illustrates a system that supports storing and retrieving a history trail for a search session in accordance with an embodiment of the present invention. The system includes a search engine 106, which is hosted by a server 107. Server 107 can generally include any computational node including a mechanism for servicing requests from a client for computational and/or data storage resources. Search engine 106 can include the Google™ search engine provided by Google, Inc. of Mountain View, Calif.

User 102 can access search engine 106 through client 104. Client 104 can generally include any node on a network including computational capability and including a mechanism for communicating across the network.

Search engine 106 performs searches within a web page repository 108, which contains an indexed representation of web pages on the Internet. Search engine 106 additionally communicates with a history trail repository 110, which stores history trails for search sessions. Note that history trail repository 110 can be accessed by a group of users, which enables members of the group to share search sessions with each other. (Also note that history trail repository 110 can optionally be stored on client 104 as is indicated by the dashed line in FIG. 1)

The present invention is not meant to be limited to search engines and web pages. In general, the present invention can be applied to any system that allows a user to navigate through different pages, screens or forms. For example, the present invention can be used to store a sequence of help pages visited by user while looking for help on a specific topic. The present invention can also be used to store a sequence of screens or forms for an application which allows a user to navigate through different screens and forms.

### Data Structures

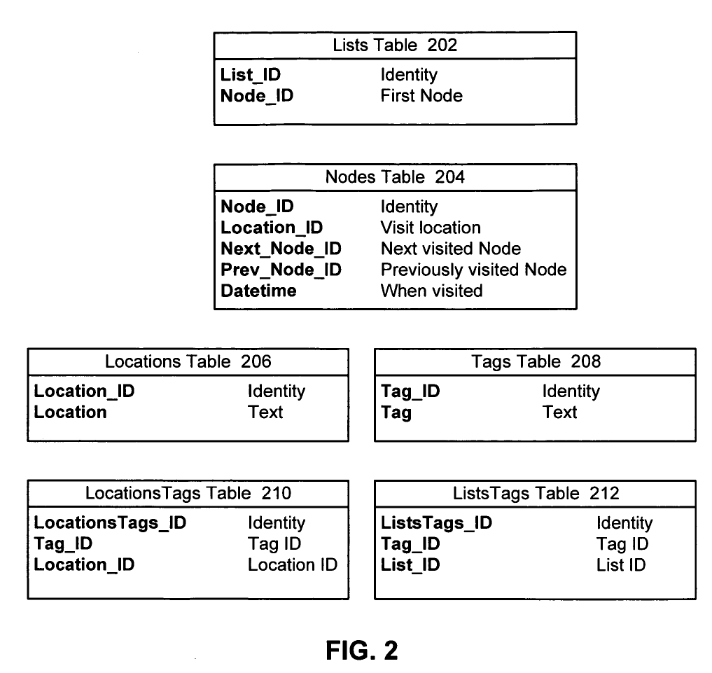

FIG. 2 illustrates exemplary data structures that support storing and retrieving a history trail in accordance with an embodiment of the present invention. These data structures include Lists table 202, Nodes table 204, Locations table 206, Tags table 208, LocationsTags table 210 and ListsTags table 212. More specifically, Lists table 202 holds a master index of all Lists stored in the system, wherein a given List comprises a history trail of Nodes visited during a specific search session along with the order and date/time of the visit. Nodes table 204 holds a master index of the time and sequence of visited locations during search sessions. (Note that a “location” can be a web address for a web page, or can be the location in an application for a specific screen.) Locations table 206 holds a master index of all visited locations. Tags table 208 holds an index of tags saved for Locations or Lists. LocationsTags table 210 holds an index of tags saved for a Location. Finally, ListsTags table 212 holds the index of tags saved for a List.

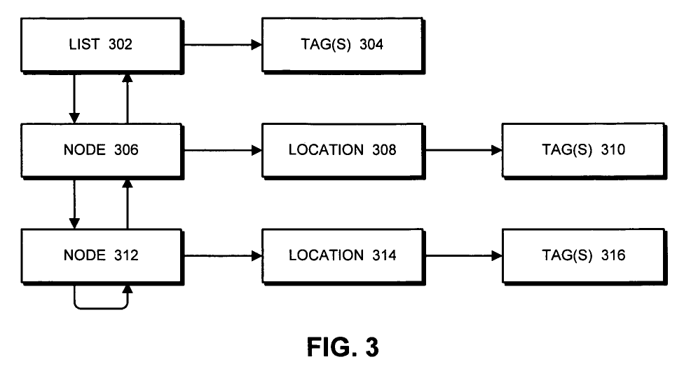

FIG. 3 illustrates an exemplary List data structure in accordance with an embodiment of the present invention. As illustrated in FIG. 3, a List can be implemented as a doubly-linked list containing one or more Nodes, and the List can be labeled with one or more Tags. In one embodiment of the present invention, Nodes are placed into the List in the order they are visited during the search session. Furthermore, a Node is associated with a single Location, and a Location can be labeled with one or more Tags. This separation of Nodes from Locations allows multiple Nodes to be associated with a single Location, which makes it easy to represent a search session where a single Location is visited multiple times. Links between nodes can optionally specify the event which caused the user to navigate between the associated locations.

Referring to FIG. 3, list 302 is associated with a doubly-linked list containing Nodes 306 and 312, and List 302 is labeled with one or more tags 304. Furthermore, Nodes 306 and 312 are associated with Locations 308 and 314, respectively, and Locations 308 and 314 are labeled with one or more Tags 310 and 316, respectively.

Note that the above-described data structures merely provide an exemplary implementation for the present invention. In general, the present invention can be implemented using many other types of data structures.

### Tagging and Storing a History Trail

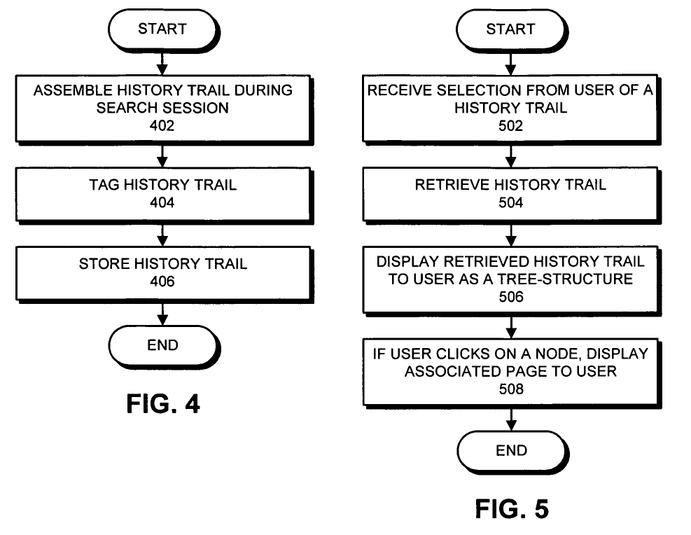

FIG. 4 illustrates the process of tagging and storing a history trail in accordance with an embodiment of the present invention. First, the system assembles a “history trail” while a user is navigating between pages during a search session (step 402). In one embodiment of the present invention, this history trail is implemented using the List data structure described above with reference to FIG. 3.

The system can also tag the history trail (step 404). This can involve allowing a user to input a tag, or alternatively, automatically generating tags from keywords used in a keyword search during the search session, or keywords within one or more pages visited during the search session. Also note that the system can automatically log pages where the user performed a specific action, such as purchasing, downloading, logging in, etc.

Finally, the system can store the history trail (step 406). This can be done automatically at the end of a search session, or the user can initiate a save operation for the entire search session, or a subset of the search session.

### Retrieving a History Trail

FIG. 5 illustrates the process of retrieving a history trail in accordance with an embodiment of the present invention. This process starts when the system receives a selection from a user of a history trail (step 502). This can involve first processing a query containing keywords entered by the user to produce query results, and then allowing the user to select a query result. Alternatively, the user can select a history trail from a set of displayed history trails. Note that the history trails can be displayed based on date/time, location, tags or user actions. History trails can also be displayed based on the size of the trail, locations that intersect multiple lists, visitation frequency and number of saved locations. Note that it is likely that the number of people that have saved a particular location or tree will be of value to someone who starts off searching the same or similar keywords.

Next, the system retrieves the selected history trail (step 504), and displays the selected history trail to the user (step 506). In one embodiment of the present invention, the selected history trail can be displayed as a tree of the pages that were visited by the user during the search session.

If a user selects a node in the tree, the system displays a corresponding page to the user (step 508). In a variation on this embodiment, the system caches pages visited during the search session in local storage, so that a subsequent search can return the pages without having to access the pages remotely. In one embodiment of the present invention, the user can move a cursor over a node to view the corresponding page associated with the node.

### EXAMPLE

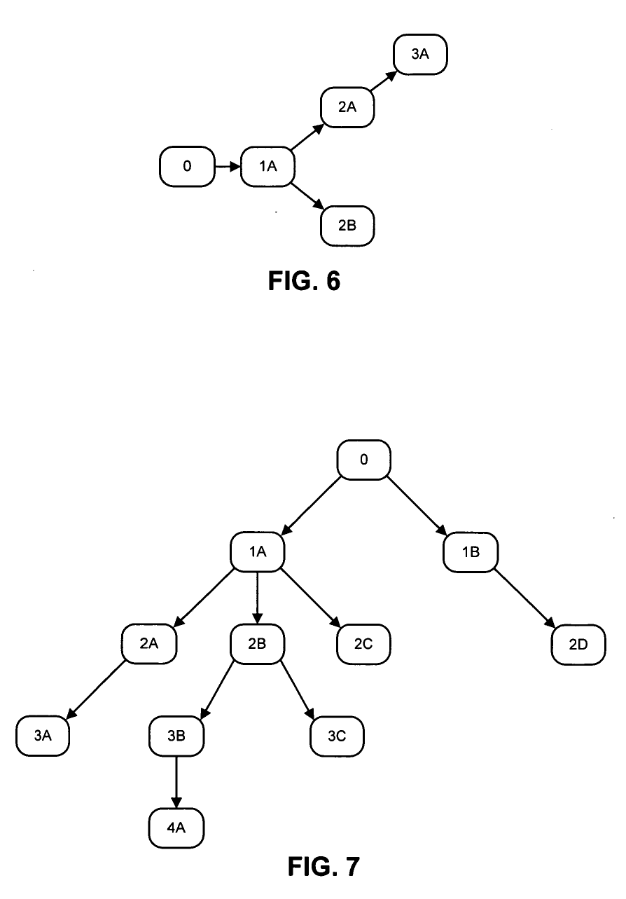

FIG. 6 illustrates a tree for an exemplary search session. This search session begins at the root page 0. From root page 0, a user navigates to page 1A, to page 2A, and then to page 3A. Next, the user clicks on a “back” button to get back to page 2A and back again to page 1A. From there, the user begins a new branch and navigates to page 2B. At this point, in other “crumb-based” navigation systems such as web browsers, the sequential navigation history to page 2A and then page 3A is lost, because moving backward takes the user from page 1A to page 0, and moving forward takes the user on the path from page 0, to page 1A, and then to page 2B.

A traditional search history under this scenario would look like this:

0→1A→2A→3A
1A←2A←
   and then the branch to a new history when 2B is accessed would look like this

0→1A→2B.

### At this point, the sequential history from 1A to 2A to 3A is lost.

In contrast, in one embodiment of the present invention, the user is presented with a representation of the navigation order as follows

0→1A→2A→3A←2A←1A→2B.

### This can be presented the user in the form of the tree which is illustrated in FIG. 6. Note that the sequential history from page 1A to page 2A to page 3A is not lost in this scenario.

Saving the navigation history for a search session is useful when more than one page visited was relevant to the search. For example, during a search session to research the history of a famous person, a user might visit web sites associated with a library, a university and an encyclopedia. Saving the entire “tree” of the search, or at least saving selected branches or nodes of the tree, is easier than trying to save individual pages in a history or a list of visited sites.

In one embodiment of the present invention, the user can click on a “save” button to permanently store the tree. A user can optionally save a tag along with the tree, which includes a word or a short phrase that describes the tree. Optionally, if the root of the tree started with a search engine query, the system can automatically create tags based on the keywords used in the query.

### User Interface

One embodiment of the present invention provides a “visualization” of a whole tree/graph as an option in a user interface. This option can be activated through a number of mechanisms, such as a toolbar button or through a key combination. The visualization enables a user to see and navigate to every page they have visited in the search session. For example user can click on any page in the visualization to immediately return to the page. One way to navigate the tree would be to have Up/Left, Down/Left, Up/Right and Down/Right navigation options in addition to Left and Right. For instance, in FIG. 6, going from 2B to 1A would be Up/Left. Then going from 1A to 2A would be Up/Right—assuming a tree on its side with the most-recently-visited paths at the bottom.

Furthermore, this visualization can include scaled-down versions of actual page screenshots. However, this might not be practical for displaying large numbers of pages if the search session is lengthy. In this case, it may be easier to simply display page names.

### Minimalist User Interface

Another embodiment of the present invention provides a minimalist version of a toolbar which includes nothing more than a “visualization” button, a “left” button, a “right” button and two sections. The first section shows a snapshot or title of every PARENT of the current page, and the second section shows a snapshot/title of every CHILD of the current page.

As the user navigates, the user can see every connecting page and can access it with just a click of the mouse. For example, for the search system tree illustrated in FIG. 7, if a user is at page 1A, the toolbar would look like

[left] [right] [tree] [0] [2A] [2B] [2C]

where selecting [left] navigates to page 1B, as does selecting [right]. (Alternatively, [left] can be represented as a dead end, which is greyed out). Selecting [tree] activates the visualization view, containing page snapshots which when selected navigate to the respective pages immediately.

Then, if the user clicks on [2B], the toolbar changes to become

[left] [right] [tree] [1A] [3B] [3C]

where selecting [left] navigates to page 2A and selecting [right] navigates to page 2C.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for storing a history trail for a search session to enable the history trail to be subsequently retrieved, comprising:
assembling a history trail of pages which are visited during the search session;
storing the history trail in a repository which contains multiple history trails associated with multiple search sessions; and
enabling a user to subsequently retrieve the history trail from the repository to obtain information related to pages which were visited during the search session.

2. The method of claim 1, wherein the method further comprises:
receiving a request from a user; and
in response the request, retrieving a previous history trail for a previous search session from the repository.

3. The method of claim 2,
wherein prior to storing the history trail, the method further comprises tagging the history trail with one or more tags; and
wherein retrieving the previous history trail involves retrieving the previous history trail based on contents of the one or more tags stored along with the previous history trail.

4. The method of claim 3, wherein tagging the history trail involves tagging the history trail with:
a user-supplied tag;
keywords used to obtain one or more pages for the search session; or
keywords within one or more pages visited during the search session.

5. The method of claim 2, wherein retrieving the previous history trail involves retrieving the previous history trail based on:
time/date information for the previous history trail;
location information for pages in the previous history trail;
size of the previous history trail;
whether locations in the previous history trail intersect locations in other history trails;
visitation frequency for the previous history trail;
number of saved locations in the previous history trail; or
user actions associated with the previous history trail.

6. The method of claim 2, further comprising displaying the previous history trail to the user as a tree structure, wherein:
nodes represent pages; and
links between nodes represent navigation operations between pages associated with the nodes.

7. The method of claim 6,
wherein the previous history trail is displayed to the user through a user interface; and
wherein the user interface allows the user to select a node to retrieve an associated page.

8. The method of claim 1, wherein the method further comprises making the repository accessible to a group of users so that the group of users can share search sessions in the repository.

9. The method of claim 1, wherein the storing operation takes place as part of a user-initiated save operation.

10. The method of claim 1, wherein the method further comprises caching pages visited during the search session in local storage, so that a subsequent search can return the pages without having to access the pages remotely.

11. The method of claim 1, wherein a given page in the history trail can include:
a web page;
a help page;
a form associated with an application;
a screen;
a document.

12. The method of claim 1, wherein the history trail stores one or more actions performed by a user.

13. The method of claim 1, wherein the search session can involve:
a keyword-based search operation that returns one or more pages; and
a navigation operation which follows a link from a current page to a next page.

14. A computer-readable storage medium storing instructions that when executed by a computer cause the computer to perform a method for storing a history trail for a search session to enable the history trail to be subsequently retrieved, the method comprising:
assembling a history trail of pages which are visited during the search session;
storing the history trail in a repository which contains multiple history trails associated with multiple search sessions; and
enabling a user to subsequently retrieve the history trail from the repository to obtain information related to pages which were visited during the search session.

15. The computer-readable storage medium of claim 14, wherein the method further comprises:
receiving a request from a user; and
in response the request, retrieving a previous history trail for a previous search session from the repository.

16. The computer-readable storage medium of claim 15,
wherein prior to storing the history trail, the method further comprises tagging the history trail with one or more tags; and
wherein retrieving the previous history trail involves retrieving the previous history trail based on contents of the one or more tags stored along with the previous history trail.

17. The computer-readable storage medium of claim 16, wherein tagging the history trail involves tagging the history trail with:
a user-supplied tag;
keywords used to obtain one or more pages for the search session; or
keywords within one or more pages visited during the search session.

18. The computer-readable storage medium of claim 15, wherein retrieving the previous history trail involves retrieving the previous history trail based on:
time/date information for the previous history trail;
location information for pages in the previous history trail;
size of the previous history trail;
whether locations in the previous history trail intersect locations in other history trails;
visitation frequency for the previous history trail;
number of saved locations in the previous history trail; or
user actions associated with the previous history trail.

19. The computer-readable storage medium of claim 15, further comprising displaying the previous history trail to the user as a tree structure, wherein:
nodes represent pages; and
links between nodes represent navigation operations between pages associated with the nodes.

20. The computer-readable storage medium of claim 19,
wherein the previous history trail is displayed to the user through a user interface; and
wherein the user interface allows the user to select a node to retrieve an associated page.

21. The computer-readable storage medium of claim 14, wherein the method further comprises making the repository accessible to a group of users so that the group of users can share search sessions in the repository.

22. The computer-readable storage medium of claim 14, wherein the storing operation takes place as part of a user-initiated save operation.

23. The computer-readable storage medium of claim 14, wherein the method further comprises caching pages visited during the search session in local storage, so that a subsequent search can return the pages without having to access the pages remotely.

24. The computer-readable storage medium of claim 14, wherein a given page in the history trail can include:
a web page;
a help page;
a form associated with an application;
a screen; or
a document.

25. The computer-readable storage medium of claim 14, wherein the history trail stores one or more actions performed by a user.

26. The computer-readable storage medium of claim 14, wherein the search session can involve:
a keyword-based search operation that returns one or more pages; and
a navigation operation which follows a link from a current page to a next page.

27. A computer system that stores a history trail for a search session to enable the history trail to be subsequently retrieved, comprising:
a processor;
a memory;
an assembly mechanism configured to assemble a history trail of pages which are visited during the search session;
a storage mechanism configured to store the history trail in a repository which contains multiple history trails associated with multiple search sessions; and
a user interface configured to enable a user to retrieve the history trail from the repository.

28. The computer system of claim 27, further comprising a retrieval mechanism configured to:
receive a request from a user; and
in response the request, to retrieve a previous history trail for a previous search session from the repository.
